(19) United States
(12) Patent Application Publication
(10) Pub. No.: US 2006/0110652 A1
(43) Pub. Date: May 25, 2006

(54) Fuel cell-use catalyst electrode and fuel cell having this catalyst electrode, and production methods therefor

(75) Inventors: Hideto Imai, Tokyo (JP); Tsutomu Yoshitake, Tokyo (JP); Yuichi Shimakawa, Tokyo (JP); Takashi Manako, Tokyo (JP); Shin Nakamura, Tokyo (JP); Hidekazu Kimura, Tokyo (JP); Sadanori Kuroshima, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/515,654

(22) PCT Filed: May 28, 2003
(86) PCT No.: PCT/JP03/06706

§ 371 Date: Aug. 26, 2005

(30) Foreign Application Priority Data
May 28, 2002 (JP) 2002-154493

(51) Int. Cl. H01M 4/86; H01M 4/02; H01M 4/88

(52) U.S. Cl. 429/40; 429/209; 502/101

(57) ABSTRACT

The present invention provides a catalyst electrode and a manufacturing method of the same. When the catalyst electrode is used for a fuel cell, it is capable of suppressing an air, which is a by-product generated at a fuel electrode on a surface of the electrode, and quickly removing the adsorbed bubble-like air. Accordingly, the catalyst electrode is capable of increasing an effective catalyst surface of the fuel electrode and enhancing an output power of the fuel cell. Moreover, the present invention provides fuel cell and a manufacturing method of the same. The fuel cell is capable of suppressing an air, which is a by-product generated at the fuel electrode on the surface of the electrode and quickly removing the adsorbed bubble-like air. Accordingly, the fuel cell is capable of increasing an effective catalyst surface of the fuel electrode and enhancing an output power thereof. In a catalyst electrode for a fuel cell provided with a substrate and a catalyst layer which is formed on the substrate and which contains a carbon particle carrying a catalyst and a solid polymer electrolyte, the substrate or the catalyst layer contains one or more kinds of anti-foaming agent.

### TECHNICAL FIELD

The present invention relates to a catalyst electrode for a fuel cell of a type which directly supplies a battery with a fuel composed of hydrogen and carbon, as well as to a fuel cell having the catalyst electrode for a fuel cell and manufacturing methods of them.

For the purpose of sufficiently explaining the current level of the art related to the present invention, descriptions of all patents, patent applications, patent gadgets, scientific literatures and the like quoted or specified herein are incorporated herein by reference in its entirety.

### BACKGROUND OF THE ART

A solid electrolyte-type fuel cell is a device configured by respectively bonding a fuel electrode and an oxidant electrode on a side of a solid electrolyte membrane such as a perfluorosulfonic acid membrane or the like which is used as an electrolyte. This device generates electric power based on an electrochemical reaction supplying hydrogen and methanol for the fuel electrode and oxygen for the oxidant electrode. When methanol is used as a fuel, an electrochemical reaction which occurs at the fuel electrode is expressed by the following chemical equation:
CH₃OH+H₂O→6H++CO₂+6e−[1],
and the electrochemical reaction which occurs at the oxidant electrode is expressed by the following chemical equation:
3/2O₂+6H++6e−→3H₂O [2].
For the purpose of causing these reactions, both the oxidant electrode and the oxidant electrode are composed of a mixture of carbon fine particles supporting a catalyst and a solid polymer electrolyte.
In this configuration, when methanol is used as a fuel, the methanol which is supplied to the fuel electrode passes through pores in the electrode and reach the catalyst. Then the methanol is degraded by the catalyst, whereby an electron and a hydrogen ion are generated based on the electrochemical reaction as shown in the chemical equation [1] as described above. The hydrogen ion passes through an electrolyte in the electrodes and the solid electrolyte membrane between the two electrodes so as to reach the oxidant electrode, where the hydrogen ion reacts with oxygen supplied to the oxidant electrode and an electron which flows into the oxidant electrode from an external circuit. Accordingly water is generated as shown in the chemical equation [2].
Meanwhile, an electron released from methanol by the electrochemical reaction as shown in the chemical equation [1] passes through a catalyst carrier in the electrodes and an electrode substrate so as to be introduced to the external circuit. Then the electron flows into the oxidant electrode via the external circuit. As a result, the electron flows from the fuel electrode to the oxidant electrode via the external circuit, whereby the electric power can be taken out.
In a conventional direct methanol fuel cell, carbon dioxide generated in accordance with the chemical equation [1] a carbon monoxide which is an intermediate product in the chemical equation [1] is collected in the pores of the fuel electrode, and thus hinders supply of the fuel. Accordingly, power generation efficiency and an effective surface area of the catalyst decrease, whereby output power is reduced. In order to avoid these drawbacks, it is necessary to remove an air such as carbon dioxide and/or carbon monoxide or the like which is adsorbed onto the surface of the electrode in a foam-like manner.

### DISCLOSURE OF THE INVENTION

It is therefore an object of the present invention to provide a catalyst electrode which is capable of, when used for a fuel cell, avoiding decrease in an effective surface area of a fuel electrode and preventing decrease in an output power of the fuel cell, by suppressing adsorption onto the surface of the electrode of an air which is a by-product produced at the fuel electrode as well as by quickly removing the foamed air which is once adsorbed thereto.

It is another object of the present invention to provide a manufacturing method of a catalyst electrode which is capable of, when used for a fuel cell, avoiding decrease in an effective surface area of a fuel electrode and preventing decrease in an output power of the fuel cell, by suppressing adsorption onto the electrode of an air which is a by-product produced on the surface of the fuel electrode as well as by quickly removing the foamed air which is once absorbed thereto.

It is a yet further object of the present invention to provide a fuel cell which is capable of, when used for a fuel cell, avoiding decrease in an effective surface area of a fuel electrode and preventing decrease in an output power of the fuel cell, by suppressing adsorption of air which is a by-product produced at the fuel electrode onto the surface of the electrode as well as by quickly removing the foamed air which is once absorbed thereto.

It is still another object of the present invention to provide a manufacturing method a fuel cell which is capable of avoiding decrease in an effective surface area of a fuel electrode and preventing decrease in an output power of a fuel cell, when it is used for a fuel cell, by suppressing adsorption of air which is a by-product produced at the fuel electrode onto the surface of the electrode as well as by quickly removing the foamed air which is once absorbed thereto.

### DISCLOSURE OF THE INVENTION

A first aspect of the present invention is a catalyst electrode for a fuel cell that comprises a substrate and a catalyst layer which is formed adjacent to the substrate and which includes a carbon particle supporting a catalyst and a solid polymer electrolyte, wherein at least one of the substrate and the catalyst layer contains at least one kind of anti-foaming agent.

An anti-foaming effect of the anti-foaming agent which is contained in the catalyst electrode for a fuel cell according to the present invention includes an effect of suppressing adsorption of an air as an air bubble which is generated by a reaction at a fuel electrode of the fuel cell, and an effect of quickly breaking and removing the generated air bubble. Accordingly, since the catalyst electrode for a fuel cell contains the anti-foaming agent, decrease in an effective surface area of the fuel electrode can be prevented, and decrease in the output power of the fuel cell is prevented.

In the catalyst electrode for a fuel cell according to the present invention, the anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, propylene glycol, low-molecular-weight polyethyleneglycol oleic ester, a low-mole-addition product of nonyl phenol ethylene oxide, and low-mole-addition product of Pluronic-type ethylene oxide. Accordingly, it is possible to suppress adsorption of an air buble to the catalyst electrode for a fuel cell and quickly break and remove the air bubble that is generated, thereby preventing decrease in the output power of the fuel cell.

Furthermore, at least one of the substrate and the catalyst layer of the catalyst electrode for a fuel cell according to the present invention may contain a single or a plurality of kinds of anti-foaming agent.

Moreover, at least one of the substrate and the catalyst layer of the catalyst electrode for a fuel cell according to the present invention may contain at least one of a mixing accelerator and a stabilizer of the anti-foaming agent. Accordingly, an effective surface area of the catalyst electrode for a fuel cell can be further increased.

Note that in the catalyst electrode for a fuel cell according to the present invention, addition of an anti-foaming agent to both of the substrate and the catalyst layer further enhances a suppression effect of adsorption of an air generated by a reaction with a fuel as an air bubble to the electrode. Therefore, it is possible to provide a catalyst electrode for a fuel cell with a further increased effective surface area.

A fuel cell according to a second aspect of the present invention comprises a solid electrolyte membrane, a fuel electrode adjacent to a first surface of the solid electrolyte membrane, and an oxidant electrode adjacent to a second surface of the solid electrolyte membrane, wherein the fuel electrode includes a substrate, and a catalyst layer which is formed adjacent to the substrate and which contains a carbon particle supporting a catalyst and a solid polymer electrolyte, and at least one of the substrate and the catalyst layer of the fuel electrode contains at least one kind of anti-foaming agent.

Since the fuel electrode contains an anti-foaming agent, the fuel cell according to the present invention is capable of suppressing adsorption of an air generated by a reaction at the fuel electrode as an air bubble and quickly breaking and removing the generated air bubble. Therefore, the effective surface area of the fuel electrode can be increased and a high output power can be provided.

Furthermore, a liquid fuel supplied to the fuel electrode may contain an organic compound and at least one kind of anti-foaming agent. In this case, the anti-foaming agent contained in the liquid fuel may include at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

The at least one kind of anti-foaming agent contained in the liquid fuel may be the same or different from the at least one kind of anti-foaming agent contained in at least one of the substrate and the catalyst layer.

A third aspect of the present invention is a manufacturing method of a catalyst electrode for a fuel cell including the step of forming a catalyst layer on a surface of a substrate coated with a solution containing a conductive particle carrying a catalyst, a particle of a solid polymer electrolyte, and at least one kind of anti-foaming agent on at least a part of the surface of the substrate.

The anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethyleneglycol oleic ester, a low-mole-addition product of nonyl phenol ethylene oxide, and a low-mole-addition product of Pluronic-type ethylene oxide.

The solution to be applied may contain at least one of a mixing accelerator and a stabilizer of the at least one kind of anti-foaming agent.

The manufacturing method of a catalyst electrode for a fuel cell may further comprise the step of bringing the substrate into contact with an anti-foaming-agent-containing substance which is in either one of a liquid state and an air state and which contains at least one kind of anti-foaming agent so as to provide the substrate with the at least one kind of anti-foaming agent, wherein a solution containing an anti-foaming agent is applied on the substrate provided with the anti-foaming agent.

The manufacturing method of a catalyst electrode for a fuel cell may further comprise the step of dispersing at least one kind of anti-foaming agent in a raw material of the substrate, so as to form the substrate in which at least one of the anti-foaming agent is dispersed, wherein a solution containing an anti-foaming agent may be applied to the substrate provided with the anti-foaming agent.

A fourth aspect of the present invention is a manufacturing method of a catalyst electrode for a fuel cell including the step of bringing a substrate into contact with an anti-foaming-agent-containing substance which contains at least one kind of anti-foaming agent and which is in either one of a liquid state and an air state so as to provide the substrate with the at least one kind of anti-foaming agent; and forming a catalyst layer on at least a part of a surface of the substrate.

The step of forming the catalyst layer may include the step of applying an application solution which contains a conductive particle carrying a catalyst substance and particles containing a solid polymer electrolyte to the substrate.

The anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethyleneglycol oleic ester, a low-mole-addition product of nonyl phenol ethylene oxide, and a low-mole-addition product of Pluronic-type ethylene oxide.

The anti-foaming-agent-containing substance may contain at least one of a mixing accelerator and a stabilizer of the at least one kind of anti-foaming agent.

The step of bringing into contact with an anti-foaming-agent-containing substance may include the step of applying the anti-foaming-agent-containing substance in a liquid state on the substrate on the substrate.

The step of bringing into contact with an anti-foaming-agent-containing substance may include the step of immersing the substrate in the anti-foaming-agent-containing substance in a liquid state.

The step of bringing into contact with an anti-foaming-agent-containing substance includes a step of spraying the anti-foaming-agent-containing substance in an air state on the substrate.

The step of forming a catalyst layer may include the step of applying a solution containing conductive particles carrying a catalyst, particles of solid polymer electrolyte, and at least one kind of anti-foaming agent to at least a part of the surface of the substrate so as to form a catalyst layer of a surface of the substrate.

A fifth aspect of the present invention is a manufacturing method of a catalyst electrode for a fuel cell which comprises the steps of: dispersing at least one kind of anti-foaming agent in a raw material of a substrate so as to form a substrate in which the at least one kind of anti-foaming agent is dispersed; and forming a catalyst layer on at least a part of a surface of the substrate.

The step of forming a catalyst layer may include the step of applying an application solution which contains a conductive particle carrying a catalyst substance and a particle containing a solid polymer electrolyte on the substrate.

The anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethyleneglycol oleic ester, a low-mole-addition product of nonyl phenol ethylene oxide, and a low-mole-addition product of Pluronic-type ethylene oxide.

At least one of a mixing accelerator and a stabilizer of the at least one kind of anti-foaming agent may be further dispersed in a raw material of the substrate.

The step of forming a catalyst layer may include the step of forming the catalyst layer coated with a solution containing a conductive particle carrying a catalyst, a particle of a solid polymer electrolyte, and at least one kind of anti-foaming agent on at least a part of the surface of the substrate.

A sixth aspect of the present invention is a manufacturing method of a catalyst electrode for a fuel cell which comprises the steps of: forming a catalyst layer on a surface of a substrate coated with a solution containing a conductive particle carrying a catalyst and a particle of a solid polymer electrolyte on at least a part of the surface of the substrate; and bringing the catalyst layer into contact with an anti-foaming-agent-containing substance which contains at least one kind of anti-foaming agent and which is in either one of a liquid state and an air state so as to provide the catalyst layer with the at least one kind of anti-foaming agent.

The anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethyleneglycol oleic ester, a low-mole-addition product of nonyl phenol ethylene oxide, and a low-mole-addition product of Pluronic-type ethylene oxide.

The anti-foaming-agent-containing substance may contain at least one of a mixing accelerator and a stabilizer of the at least one kind of anti-foaming agent.

The step of bringing into contact with the anti-foaming-agent-containing substance may comprise the step of applying the anti-foaming-agent-containing substance in a liquid state on the substrate.

The step of step of bringing into contact with the anti-foaming-agent-containing substance may include the step of immersing the substrate in the anti-foaming-agent-containing substance in a liquid state.

The step of bringing into contact with an anti-foaming-agent-containing substance includes a step of spraying the anti-foaming-agent-containing substance in an air state on the substrate

A seventh aspect of the present invention is a manufacturing method of a fuel cell which includes the steps of: forming a catalyst layer so as to obtain a catalyst electrode coated with a solution containing a conductive particle carrying a catalyst, a particle of a solid polymer electrolyte, and at least one kind of anti-foaming agent on at least a part of a surface of a substrate; and abutting and pressure-bonding the catalyst electrode with a solid electrolyte membrane.

An eighth aspect of the present invention is a manufacturing method of a fuel cell which comprises the steps of: bringing a substrate into contact with an anti-foaming-agent-containing substance which contains at least one kind of anti-foaming agent and which is in either one of a liquid state and an air state so as to provide the substrate with the at least one kind of anti-foaming agent; forming a catalyst layer on at least a part of a surface of a substrate so as to obtain a catalyst electrode; and abutting and pressure-bonding the catalyst electrode with a solid electrolyte membrane.

A ninth aspect of the present invention is a manufacturing method of a fuel cell which comprises the steps of: dispersing at least one kind of anti-foaming agent in a raw material of a substrate so as to form the substrate in which the at least one kind of anti-foaming agent is dispersed; forming a catalyst layer on at least a part of a surface of the substrate, so as to obtain a catalyst electrode; and abutting and pressure-bonding the catalyst electrode with a solid electrolyte membrane.

A tenth aspect of the present invention is a manufacturing method of a fuel cell which comprises the steps of: forming a catalyst layer coated with a solution containing a conductive particle carrying a catalyst and a particle of a solid polymer electrolyte on at least a part of a surface of a substrate; obtaining a catalyst electrode by bringing the catalyst layer into contact with an anti-foaming-agent-containing substance which contains at least one kind of anti-foaming agent and which is in either one of a liquid state and an air state so as to provide the catalyst layer with the at least one kind of anti-foaming agent; and abutting and pressure-bonding the catalyst electrode with a solid electrolyte membrane.

### BRIEF DESCRIPTION OF THE DRAWINGS

FIG. 1 is a cross sectional view which schematically shows a typical example of an internal structure of a fuel cell according to the present invention.

FIG. 2 is a cross sectional view which schematically shows a fuel electrode, an oxidant electrode, and a solid polymer electrolyte membrane in a typical example of a fuel cell according to the present invention.

### BEST MODES FOR CARRYING OUT THE INVENTION

The present invention relates to a catalyst electrode for a fuel cell, a fuel cell having the catalyst electrode for a fuel cell and manufacturing methods of them. The catalyst electrode is capable of, when used for a fuel cell, avoiding decrease in an effective surface area of a fuel electrode and preventing decrease in an output power of the fuel cell, by suppressing adsorption onto the surface of the electrode of an air which is a by-product produced at the fuel electrode as well as by quickly removing the foamed air which is once adsorbed thereto.

The present invention provides a catalyst electrode for a fuel cell capable of suppressing adsorption to a surface of an electrode of an air, which is a by-product generated at a fuel electrode when it is used in a fuel cell and quickly removing the adsorbed air bubble, thereby increasing an effective catalyst area of the fuel electrode and increasing an output power of the fuel cell, and provides a fuel cell including the electrode and a manufacturing method of them.

The best mode for carrying out the invention as described below is a typical example of the best mode for embodying the plurality of aspects of the present invention which were sufficiently explained previously in the disclosure of the present invention. Although a subject matter of the present invention is as sufficiently explained previously in the disclosure of the present invention, further explanation of one or more preferred embodiments as below with reference to the attached drawings will facilitate understanding of the best mode for carrying out the invention.

A catalyst electrode for a fuel cell according to the present invention includes a substrate; and a catalyst layer which is formed on the substrate and which contains a carbon particle supporting a catalyst and a solid polymer electrolyte, wherein at least one of the substrate and the catalyst layer contains at least one kind of anti-foaming agent.

When liquid fuel is supplied to a catalyst electrode for a fuel cell according to the present invention, in some cases, a reaction product or a by-product of an organic substance which is a major component of the fuel may be generated as an air and an air bubble. Even in this case, at least one kind of anti-foaming agent contained in at least either one of the substrate and the catalyst layer suppresses adsorption of the air bubble onto a surface of the electrode, and even in the case where the air bubble is adsorbed onto the surface of the electrode, the anti-foaming agent quickly breaks the air bubble or removes it from the surface of the electrode. Therefore, decrease in power generation efficiency caused by a decreased effective surface area of the catalyst electrode and a decrease in an output power of the fuel cell can be suppressed.

Since both the substrate and the catalyst layer of the catalyst electrode of the present invention contains the anti-foaming agent, when the catalyst electrode is used as a fuel electrode of the fuel cell, adsorption of the air bubble onto the surface of the electrode can be further suppressed.

A typical example of the anti-foaming agent of the present invention may include a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, and other organic polar compound-based and mineral oil-based anti-foaming agent, but is not limited to these.

A typical example of the fatty acid-based anti-foaming agent may include stearic acid, oleic acid, and palmitic acid, but is not limited to these.

A typical example of the fatty acid ester-based anti-foaming agent may include isoamyl stearate, distearyl succinate, ethylene glycol distearate, sorbitan monolaurate ester, polyoxyethylene sorbitan monolaurate ester, sorbitan oleate triester, butyl stearate, glyceryl monoricinoleate ester, diethylene glycol monoleic ester, diglycol esterdinaphthenate ester and monoglyceride, but is not limited to these.

The alcohol-based anti-foaming agent according to the present embodiment includes a fatty-alcohol-based anti-foaming agent and a long-chain-alcohol-based anti-foaming agent. A typical example of the alcohol-based anti-foaming agent may include polyoxy alkylene glycol and its derivatives, polyoxy alkylene monohydric alcohol di-t-amyl phenoxyethanol, 3-heptanol, 2-ethyl hexanol and di-isobutyl carbinol, but is not limited to these.

A typical example of the ether-based anti-foaming agent may include di-t-amyl phenoxyethanol, 3-heptyl cellosolve nonyl cellosolve and 3-heptyl carbitol, but is not limited to these.

A typical example of the phosphate based anti-foaming agent may include tributyl phosphate, sodium octyl phosphate, and tris(butoxyethyl) phosphate, but is not limited to these.

A typical example of the amine-based anti-foaming agent may include diamyl amine, but is not limited to this.

A typical example of the amide-based anti-foaming agent may include polyalkylene amide, acylate polyamine and di-octadecanoyl piperazine, but is not limited to these.

A typical example of the metal soap-based anti-foaming agent may include aluminum stearate, calcium stearate, potassium oleate, and calcium salt of wool oleic acid, but is not limited to these.

A typical example of the sulfate based anti-foaming agent may include sodium lauryl sulfate ester, but is not limited to this.

A typical example of the silicone-based anti-foaming agent may include dimethylpolysiloxane, silicone paste, silicone emulsion, siliconized powder, organic modifier polysiloxane and fluorine silicone, but is not limited to these.

A typical example of the other organic polar compound-based anti-foaming agent may include polypropylene glycol, low-molecular-weight polyethylene glycol oleic ester, a low-mole-addition product of nonyl phenol ethylene oxide (EO) and a low-mole-addition product of Pluronic-type EO, but is not limited to these.

A typical example of the mineral oil-based anti-foaming agent may include a compounding agent of a mineral oil-based surface-active-agent, and a compounding agent of a mineral-oil and fatty acid metal salt-based surface-active-agent, but is not limited to these.

A catalyst electrode for a fuel cell according to the present invention contains, for example, the above-mentioned substances as the anti-foaming agent. Accordingly, when the catalyst electrode is applied in a fuel cell, it is capable of quickly removing air bubbles made of such as carbon dioxide or carbon monoxide which are generated on a surface of the catalyst and of maintaining an effective surface area of the catalyst electrode, thereby increasing an output power of the fuel cell.

Note that one kind of the anti-foaming agent may be independently used, or two or more kinds thereof may be mixed for use.

Furthermore, as may be necessary, one or multiple kinds of surface-active-agents, inorganic powders made of such as calcium carbonate or the like may be used as a mixing accelerator and a dispersion stabilizer of the anti-foaming agent. As a surface-active-agent, polyethylene glycol diester laurate may be used.

A fuel cell according to the present invention includes a fuel electrode, an oxidant electrode and an electrolyte layer. The fuel electrode and the oxidant electrode are collectively referred to as a catalyst electrode. A liquid fuel for a fuel cell which contains an organic compound containing a carbon atom and a hydrogen atom is supplied to the fuel electrode.

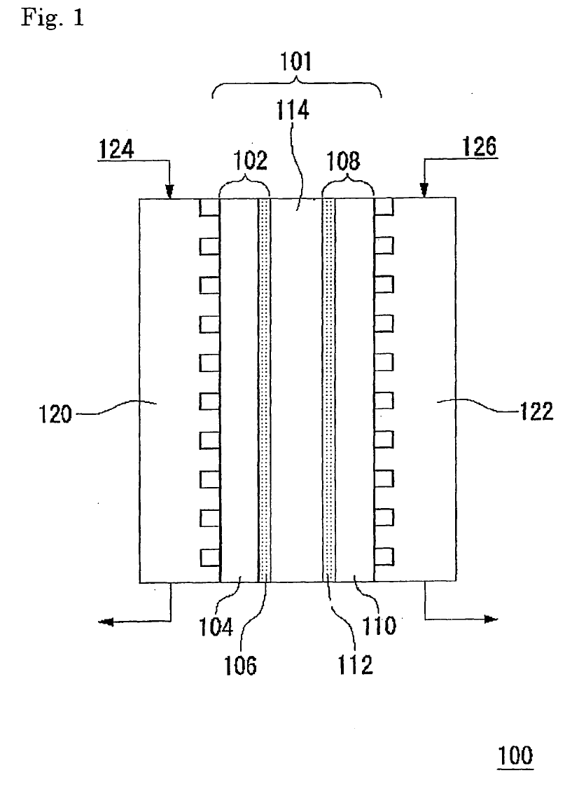

FIG. 1 is a sectional view which schematically shows a structure of the fuel cell according to the present embodiment. An assembly 101 of two catalyst electrodes and a solid electrolyte membrane is configured by a fuel electrode 102, an oxidant electrode 108 and a solid electrolyte membrane 114. The fuel electrode 102 is further configured by a substrate 104 and a catalyst layer 106. The oxidant electrode 108 is further configured by a substrate 110 and a catalyst layer 112. A fuel cell 100 is configured by the above-mentioned assembly 101 of the plurality of the catalyst electrodes and the solid electrolyte membrane, a fuel electrode-side separator 120 and an oxidant electrode-side separator 122 that sandwich the assembly 101.

In the fuel cell 100 with the aforementioned configuration, a fuel 124 is supplied to the fuel electrode 102 of the catalyst electrodes-solid electrolyte membrane assembly 101 via the fuel electrode-side separator 120.

Moreover, an oxidant 126 such as air, oxygen or the like is supplied to the oxidant electrode 108 of the catalyst electrodes-solid electrolyte membrane assembly 101.

The solid electrolyte membrane 114 of the fuel cell according to the present invention partitions the fuel electrode 102 and the oxidant electrode 108, and plays a role of a transfer medium of a hydrogen ion and a water molecule between the fuel electrode 102 and the oxidant electrode 108. For this reason, it is preferable that the solid electrolyte membrane 114 is a membrane having high conductivity of hydrogen ions. Furthermore, it is preferable that the solid electrolyte membrane 114 is chemically stable and has a high mechanical strength. A typical example of a material constituting the solid electrolyte membrane 114 may include an organic polymer having a poral radical such as a strong acid group such as a sulfonic group, a phosphate group, a phosphonic group, a phosphinic group or the like, and a weak acid group such as a carboxyl group, but is not limited to these. A typical example of the organic polymer may include a polymer containing aromatic organic such as sulfonated poly (4-phenoxy benzoyl-1,4-phenylene), alkyl-sulfonated polybenzimidazole, a copolymer such as polystyrene sulfonate copolymer, polyvynil sulfonate copolymer, cross-linked alkyl sulfonate derivatives, and a polymer containing fluorosis constituted by fluorocarbon resin skeleton and sulfonic acid, a copolymer obtained by copolymerization of acrylamides such as acrylamide 2-methyl propane sulfonate and acrylates such as n-butyl methacrylate, perfluorocarbon containing a sulfonic group (Nafion (manufactured by DuPont: registered trademark), Aciplex (manufactured by Asahi Kasei Corporation)), and perfluorocarbon containing a carboxyl group (Flemion S (manufactured by Asahi Glass Company: registered trademark)), but is not limited to these. Among these substances, when polymers containing an aromatic organic such as sulfonated poly (4-phenoxy benzoyl-1,4-phenylene) and alkyl-sulfonated polybenzimidazole are selected, permeation of organic liquid fuel and decrease in battery efficiency caused by a crossover can be suppressed.

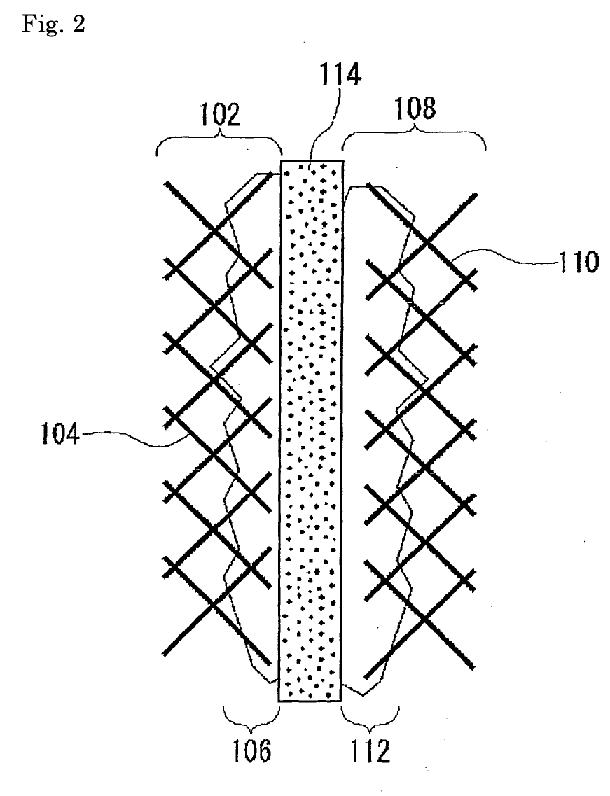

FIG. 2 is a sectional view schematically showing structures of the fuel electrode 102, the oxidant electrode 108, and the solid electrolyte membrane 114. As shown in the drawing, the fuel electrode 102 and the oxidant electrode 108 according to the present embodiment may contain, for example, a carbon particle carrying a catalyst and fine particles of a solid polymer electrolyte. The fuel electrode 102 is configured by the substrate 104 and the catalyst layer 106 formed on the substrate 104. The oxidant electrode 108 is configured by the substrate 110 and the catalyst layer 112 formed on the substrate 110. Note that surfaces of the substrates 104 and 110 may be subjected to the water repellant treatment.

A porous substrate such as carbon paper, carbon compact, sintered carbon, sintered metal, and foamed metal may be used as the substrate 104 and the substrate 110. Moreover, a water-repellant agent such as poly-tetrafluoroethylene may be used for the water repellant treatment of the substrate.

Platinum, rhodium, palladium, iridium, osmium, ruthenium, rhenium, gold, silver, nickel, cobalt, lithium, lanthanum, strontium, yttrium or the like is exemplified as a catalyst of the fuel electrode 102. One kind of these may be used independently, or two or more kinds of these may be combined for use. Meanwhile, the same catalyst of the fuel electrode 102 may be used as a catalyst for the oxidant electrode 108, and the substances as exemplified above may be used. Note that the catalyst of the fuel electrode 102 may be either the same as or different from that of the oxidant electrode 108.

Acetylene Black (such as Denka Black (manufactured by Denki Kagaku Kogyo Kabushiki Kaisha: registered trademark) and XC72 (manufactured by Vulcan. Inc.)), Ketjenblack, amorphous carbon, carbon nanotube, carbon nanohorn and the like are exemplified as a carbon particle carrying a catalyst. A particle diameter of a carbon particle is, for example, no less than 0.01 μm and no more than 0.1 μm, and preferably no less than 0.02 μm and no more than 0.06 μm.

Moreover, the solid polymer electrolyte which is a constituent of the fuel electrode 102 and the oxidant electrode 108 that serve as the catalyst electrodes plays a role of electrically connecting a carbon particle carrying a catalyst and the solid electrolyte membrane 114, as well as of delivering an organic liquid fuel to the surface of the catalyst. For this purpose, conductivity of hydrogen ions and mobility in the water are required. Furthermore, the fuel electrode 102 is required to have permeability of an organic liquid fuel such as methanol. Moreover, the oxidant electrode 108 is required to have permeability of oxygen. In order to satisfy these demands, a material having a conductivity of hydrogen ions and permeability of the organic liquid fuel such as methanol is preferably used as a solid polymer electrolyte.

Specifically, an organic polymer having a poral radical with a strong acid group such as a sulfonic group and a phosphate group and a weak acid group such as a carboxyl group are preferably used. A typical example of these polymerorganic polymers may include perfluorocarbon containing a sulfonic group (such as Nafion (manufactured by DuPont) and Aciplex (manufactured by Asahi Kasei Corporation)), perfluorocarbon containing a carboxyl group (such as Flemion S (manufactured by Asahi Glass Company)), polystyrene sulfonate copolymer, polyvinyl sulfonate copolymer, cross-linked alkyl sulfonate derivatives, a copolymer such as a polymer containing fluorosis constituted by fluorosis carbon resin skeleton and sulfonic acid, and a copolymer obtained by copolymerization of acrylamides such as 2-methyl propane sulfonate and acrylates such as n-butyl methacrylate, but is not limited to these.

Furthermore, a typical example of the polymer to which the polar radical is bonded includes polybenzimidazole derivatives, polybenzioxazole derivatives, polyethyleneimine cross-linked body, polycylamine derivatives, amine-substituted polystyrene such as polydiethyl aminoethyl polystyrene, resin having a nitrogen group or a hydroxyl group such as nitrogen-substituted polyacrylate such as diethylaminoethylpolymethacrylate, polysiloxane containing silanol, poly acrylic resin containing a hydroxyl group represented by hydroxylethyl polymethyl acrylate and polystyrene resin containing a hydroxyl group represented by parahydroxypolystyrene, but is not limited to these.

Moreover, a cross-linked substituent, for example, such as a vinyl group, an epoxy group, an acrylic group, a methacrylic group, a cinnamoylic group, a methylolic group, an azido group, and a naphthoquinone diazido group may be, as appropriate, introduced into these polymers.

The above-described solid polymer electrolyte of the fuel electrode 102 may be the same or different from that of the oxidant electrode 108.

As an organic compound contained in the liquid fuel according to the present invention, alcohols such as methanol, ethanol and propanol, ethers such as dimethylether, cycloparaffins such as cyclohexane, cycloparaffins having a hydrophilic group such as a hydroxyl group, a carboxyl group, an amino group, and an amide group, and one-substitution and two-substitution of cycloparaffin may be used. Cycloparaffins herein is cycloparaffin and its substitutions, and a substance other than aromatic compounds is used.

Note that it is important for the catalyst electrode to contain at least one kind of anti-foaming agent in the present invention. However, as a preferred modification, in addition to the catalyst electrode, the liquid fuel for a fuel cell may further contain the above mentioned at least one kind of anti-foaming agent. By adding the anti-foaming agent both in the catalyst electrode and the above-mentioned liquid fuel for a fuel cell, the aforementioned effect of the anti-foaming agent contained in the catalyst electrode can be further enhanced. The anti-foaming agent contained in the aforementioned liquid fuel may be of the same kind as or a different kind from that contained in the catalyst electrode. Furthermore, in the liquid fuel, a single kind of anti-foaming agent may be independently used, or a multiple kinds of anti-foaming agent may be combined for use.

A typical example of the anti-foaming agent contained in the liquid fuel according to the present invention may include a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, other organic polar compound-based anti-foaming agents, and a mineral-oil based anti-foaming agent, but is not limited to these.

A preferable addition amount of the anti-foaming agent with respect to a liquid containing the organic compound depends on a kind of the anti-foaming agent, but is typically no less than 0.00001 w/w % and no more than 2 w/w. The addition amount of the anti-foaming agent of no less than 0.00001 w/w % enables the effect of quickly removing an air bubble onto the surface of the electrode to be realized when it is used for the catalyst electrode for a fuel cell. Furthermore, the addition amount of the anti-foaming agent of no more than 2 w/w % maintains a dispersion stability of the anti-foaming agent.

A typical example of the fatty acid-based anti-foaming agent may include stearic acid, oleic acid and palmitic acid, but is not limited to these. These fatty acid-based anti-foaming agent with an amount in the range no less than 0.001 w/w % and no more than 2 w/w %, is preferably added to a liquid containing the organic compound, when it is used. The addition amount of these fatty acid-based anti-foaming agents of no less than 0.001 w/w % remarkably realizes an effect of quickly removing an air bubble on the surface of the electrode when it is used for the catalyst electrode for a fuel cell. Furthermore, the addition amount of these fatty acid-based anti-foaming agents of no less than 2 w/w % enables dispersion stability of the anti-foaming agent to be preferably maintained.

A typical example of the fatty acid ester-based anti-foaming agent may include isoamyl stearate, distearyl succinate, ethylene glycol distearate, sorbitan monolaurate ester, polyoxyethylene sorbitan monolaurate ester, sorbitan triester, butyl stearate, glyceryl monoricinoleate ester, diethylene glycol monoleic ester, diglycol dinaphthenate ester and monoglyceride, but is not limited to these. When isoamyl stearate, distearyl succinate or ethylene glycol is used as a fatty acid ester-based anti-foaming agent, an anti-foaming agent with a content of no less than 0.05 w/w % and no more than 2 w/w % may be added with respect to a liquid containing the aforementioned organic compound. Furthermore, when a fatty acid ester-based anti-foaming agent other than these is used, it is preferable that an anti-foaming agent with a content of no less than 0.02 w/w % and no more than 0.2 w/w % is added to a liquid containing the aforementioned organic compound. In the respective cases as described above, an addition of amount of the fatty acid ester-based anti-foaming agent of no less than 0.05 w/w % and no less than 0.002 w/w % remarkably realizes an effect of quickly removing an air bubble on the surface of the electrode when it is used in the catalyst electrode for a fuel cell. Furthermore, respective addition amounts of the fatty acid ester-based anti-foaming agent of no more than 2 w/w % and no more than 0.2 w/w % enables dispersion stability of the anti-foaming agent to be preferably maintained.

An alcohol-based anti-foaming agent according to the present embodiment includes a fatty-alcohol-based anti-foaming agent and a long-chain-alcohol-based anti-foaming agent. A typical example of the alcohol-based anti-foaming agent may include Polyoxyalkyleneglycol and its derivatives, polyoxy alkylene monohydric alcohol di-t-amyl phenoxyethanol, 3-heptanol, 2-ethylhexanol, and diisobutyl carbinol, but is not limited to these. When an polyoxy alkylene glycol and its derivatives are used as the alcohol-based anti-foaming agent, the anti-foaming agent with a content of no less than 0.001 w/w % and no more than 0.01 w/w % may be added to a liquid containing the organic compound. Furthermore, when other alcohol-based anti-foaming agent other than these is used, an anti-foaming agent with a content of no less than 0.25 w/w % and no more than 0.3 w/w % is preferably added to the liquid containing the aforementioned organic compound. Furthermore, in the respective cases, an addition amount of an alcohol-based anti-foaming agent of no less than 0.001 w/w % and no more than 0.025 w/w % enables realizing an effect of quickly removing an air bubble on the surface of the electrode when it is used for a fuel cell. Furthermore, in the respective cases as above, addition amounts of the alcohol-based anti-foaming agent of no more than 0.01 w/w % and no more than 0.3 w/w %, respectively, enable dispersion stability of the anti-foaming agent to be preferably maintained.

A typical example of the ether-based anti-foaming agent may include di-t-amylphenoxyethanol, 3-heptyl cellosolve-nonylcellosolve, and 3-heptyl carbitol, but is not limited to these. When these ether-based anti-foaming agents are used, it is preferable that the anti-foaming agent with an amount of no less than 0.025 w/w % and no more than 0.25 w/w % is added with respect to the liquid containing the organic compound. Furthermore, the addition amount of the anti-foaming agent of no less than 0.025 w/w % allows an effect of quickly removing the air bubble on the surface of the electrode to be remarkably realized, when it is used for a catalyst electrode for a fuel cell. Moreover, the addition amount of the anti-foaming agent of no more than 0.25 w/w % allows dispersion stability of the anti-foaming agent to be preferably maintained.

A typical example of the phosphate based anti-foaming agent may include tributylphosphate, sodium octyl phosphate, and tris(butoxyethyl) phosphate, but is not limited to these. When these phosphate based anti-foaming agents are used, it is preferable that the anti-foaming agent with a content of no less than 0.001 w/w % and no more than 2 w/w % is added with respect to the liquid containing the aforementioned organic compound. Furthermore, an addition amount of the anti-foaming agent of no less than 0.001 w/w % allows an effect of quickly removing the air bubble on the surface of the electrode to be remarkably realized when it is used for a catalyst electrode for a fuel cell. Moreover, an addition amount of the anti-foaming agent of no more than 2 w/w % enables dispersion stability of the anti-foaming agent to be preferably maintained.

A typical example of the amine-based anti-foaming agent may include diamylamine, but is not limited to this. When diamylamine is used as the anti-foaming agent, it is preferable that the anti-foaming agent with a content of no less than 0.02 w/w % and no more than 2 w/w % is added with respect to the liquid containing the aforementioned organic compound. Furthermore, an addition amount of the anti-foaming agent of no less than 0.02 w/w % allows an effect of quickly removing the air bubble on the surface of the electrode to be remarkably realized, when it is used for a catalyst electrode for a fuel cell. Moreover, an addition amount of the anti-foaming agent of no less than 2 w/w % allows dispersion stability of the anti-foaming agent to be preferably maintained.

A typical example of the amide-based anti-foaming agent may include, polyalkyleneamide, acylatepolyamine, and dioctadecanoyl piperazine, but is not limited to these. When these amide-based anti-foaming agents are used, it is preferable that the anti-foaming agent with a content of no less than 0.002 w/w % and no more than 0.005 w/w % is added with respect to the liquid containing the aforementioned organic compound. Furthermore, an addition amount of the anti-foaming agent of no less than 0.002 w/w % allows an effect of quickly removing the air bubble on the surface of the electrode to be remarkably realized, when it is used for a catalyst electrode for a fuel cell. Moreover, an addition amount of the anti-foaming agent of no more than 0.005 w/w % allows dispersion stability of the anti-foaming agent to be preferably maintained.

A typical example of the metal soap-based anti-foaming agent may include stearate aluminum, calcium stearate, potassium oleate, and calcium salt of wool oleic acid, but is not limited to these. When these metal soap-based anti-foaming agents are used, the anti-foaming agent with a content of no less than 0.01 w/w % and no more than 0.5 w/w % may be added with respect to the liquid containing the aforementioned organic compound. An addition amount of the anti-foaming agent of no less than 0.01 w/w % allows an effect of quickly removing the air bubble on the surface of the electrode to be remarkably realized, when it is used for a catalyst electrode for a fuel cell. Moreover, an addition amount of the anti-foaming agent of no more than 0.5 w/w % allows dispersion stability of the anti-foaming agent to be preferably maintained.

A typical example of the sulfate based anti-foaming agent may include sodium lauryl sulfate ester, but is not limited to this. When sodium lauryl sulfate ester is used as the anti-foaming agent, it is preferable that the anti-foaming agent with a content of no less than 0.002 w/w % and no more than 0.1 w/w % is added with respect to the liquid containing the aforementioned organic compound. The addition amount of the anti-foaming agent of no less than 0.002 w/w % allows an effect of quickly removing the air bubble on the surface of the electrode to be remarkably realized, when it is used for a catalyst electrode for a fuel cell. Moreover, an addition amount of the anti-foaming agent of no more than 0.1 w/w % allows dispersion stability of the anti-foaming agent to be preferably maintained.

A typical example of the silicone-based anti-foaming agent may include dimethylpolysiloxane, silicone paste, silicone emulsion, siliconized powder, organic modifier polysiloxane and fluorine silicone, but is not limited to these. When these silicone-based anti-foaming agents are used, it is preferable that the anti-foaming agent with a content of no less than 0.00002 w/w % and no more than 0.01 w/w % may be added with respect to the liquid containing the aforementioned organic compound. An addition amount of the anti-foaming agent of no less than 0.00002 w/w % allows an effect of quickly removing the air bubble on the surface of the electrode to be remarkably realized, when it is used for a catalyst electrode for a fuel cell. Furthermore, an addition amount of the anti-foaming agent of no more than 0.01 w/w % allows dispersion stability of the anti-foaming agent to be preferably maintained.

A typical example of the other organic polar compound-based anti-foaming agent may include polypropylene glycol, low-molecular-weight polyethylene glycol oleic ester, a low-mole-addition product of nonyl phenol ethylene oxide (EO), and a low-mole-addition product of a Pluronic-type EO, but is not limited to these. When these organic polar compound-based anti-foaming agents are used, the anti-foaming agent with a content of no less than 0.00001 w/w % and no more than 2 w/w % may be added with respect to the liquid containing the aforementioned organic compound. An addition amount of the anti-foaming agent of no less than 0.00001 w/w % allows an effect of quickly removing the air bubble on the surface of the electrode to be remarkably realized, when it is used for a catalyst electrode for a fuel cell. Furthermore, an addition amount of the anti-foaming agent of no more than 2 w/w % allows dispersion stability of the anti-foaming agent to be preferably maintained.

A typical example of the mineral oil-based anti-foaming agent may include an mineral-oil based surface-active-agent-based compounding agent and a surface-active-agent-based compounding agent of mineral-oil and fatty acid metal salt, but is not limited to these. When these mineral oil-based anti-foaming agents are used, it is preferable that the anti-foaming agent with a content of no less than 0.01 w/w % and no more than 2 w/w % is added with respect to the liquid containing the aforementioned organic compound. An addition amount of the anti-foaming agent of no less than 0.01 w/w % allows an effect of quickly removing the air bubble on the surface of the electrode to be remarkably realized, when it is used for a catalyst electrode for a fuel cell. Furthermore, an addition amount of the anti-foaming agent of no more than 2 w/w % allows dispersion stability of the anti-foaming agent to be preferably maintained.

In addition to the catalyst electrode as described, the liquid fuel for a fuel cell also contains, for example, a substance as described above as an anti-foaming agent. Accordingly, when the anti-foaming agent is applied for a fuel cell, it is capable of quickly removing the air bubble made of such as carbon dioxicide and carbon monoxide which is generated on the catalyst surface, and further of increasing an effect of maintaining an effective surface area of the catalyst electrode. Therefore, the output power of the fuel cell can be further increased.

With regard to the anti-foaming agent contained in the liquid fuel for a fuel cell in addition to the catalyst electrode, one kind of the anti-foaming agent may be independently used, or two or more kinds thereof may be mixed for use. It is preferable that the mixed anti-foaming agent is dissolved or dispersed in the fuel. A typical combination example of a plurality of the anti-foaming agents may include a combination of 0.1 w/w % of stearic acid, 0.01 w/w % of tributyl phosphate and 0.005 w/w % of dimethyl polysiloxane; and a combination of 0.05 w/w % of sorbitan oleate triester, 0.1 w/w % of 3-heptyl carbitol, 0.1 w/w % of diamyl amine, 0.05 w/w % of stearate aluminum and 0.05% of laurate ester sodium, but is not limited to these combination.

Furthermore, as a mixing accelerator or a dispersion stabilizer of the anti-foaming agent contained in the liquid fuel for a fuel cell in addition to the catalyst electrode, one or a plurality of kinds of surface-active-agents, and inorganic powders made of such as calcium carbonate may be used, as may be necessary. For example, polyethylene glycol diester laurate may be used as the surface-active-agent. Furthermore, it is preferable that the surface-active-agent with a content of no less than 0.00001 w/w % and no more than 2 w/w % is added with respect to the liquid containing the aforementioned organic compound.

A manufacturing method of a catalyst electrode for a fuel cell according to the present invention is not particularly limited, and, for example, a catalyst electrode may be prepared in the following manner.

First, the catalyst of the catalyst electrode may be carried by a carbon particle using an immersion method which is commonly used. Next, the carbon particle carrying the catalyst and particles of a solid polymer electrolyte are dispersed in a solvent and made to a paste-like form. Then the paste is applied on the substrate and dried, whereby a catalyst layer is formed on the substrate. Accordingly, the catalyst electrode containing the anti-foaming agent can be used.

The anti-foaming agent can be contained in a substrate by brining the substrate into contact with liquid or air containing an anti-foaming agent. For example, the substrate can be immersed in a liquid containing an anti-foaming agent. Alternatively, a liquid containing an anti-foaming agent may be applied on or air containing an anti-foaming agent may be sprayed on a surface of the substrate. Moreover, an alcohol/water solution of such as ethanol and methanol may be used as a solvent for dispersing an anti-foaming agent. Furthermore, an anti-foaming agent may be dispersed in a raw material of the substrate when the substrate is prepared.

Furthermore, an anti-foaming agent may be dispersed in a material of a catalyst layer during the step of forming the catalyst layer. For example, mixing an anti-foaming agent in a catalyst paste allows the anti-foaming agent to be dispersed in the catalyst layer.

A particle diameter of a carbon particle in the catalyst paste is, for example, no less than 0.01 μm and no more than 0.1 μm. A particle diameter of a particle of the catalyst is, for example, no less than 1 nm and no more than 10 nm. Furthermore, a particle diameter of a particle of the solid polymer electrolyte is, for example, no less than 0.05 μm and no more than 1 μm.

The a carbon particle and a particle of the solid polymer electrolyte are used, for example, with a ratio of 2:1 to 40:1 in weight. Furthermore, a ratio in weight of water and solute in the paste is, for example, approximately 1:2 to 10:1. In this case, mixing of an anti-foaming agent in the catalyst paste allows the anti-foaming agent to be dispersed in the catalyst layer.

A method of applying the paste on the substrate is not particularly limited, but, a method such as brush painting, spray application and screen-printing may be used. A paste with a thickness of, for example, approximately no less than 1 μm and no more than 2 mm is applied. After the paste is applied, the substrate is heated at a heating temperature and a heating time depending on a fluorocarbon resin to be used, whereby the fuel electrode or the oxidant electrode are prepared. The heating temperature and the heating time are selected as appropriate depending on a material to be used, but, for example, the heating temperature may be no less than 100° C. and no more than 250° C. and the heating time may be no less than 30 seconds and no more than 30 minutes.

Furthermore, in place of the method of adding an anti-foaming agent when the catalyst layer is prepared, the catalyst electrode is allowed to contain an anti-foaming agent by applying an anti-foaming agent-dispersing solution on a surface of the thus obtained catalyst electrode.

In the manufacturing methods as described above, the anti-foaming agent may be contained in both or either one of the substrate and the catalyst layer. The anti-foaming agent being contained in both of the substrate and the catalyst layer enables further suppression of adsorption of the air bubble.

Furthermore, using the catalyst electrode for a fuel cell which is manufactured according to the method as described above, a fuel cell may be prepared in the following manner.

A solid electrolyte membrane according to the present invention may be prepared by adopting an appropriate method depending on a material to be used. For example when the solid electrolyte membrane is configured by an organic polymer material, the solid electrolyte membrane may be obtained in a manner, in which a liquid in which the polymer material is dissolved or dispersed in a solvent may be cast and dried on a peelable sheet made of such as polytetra-fluoroethylene.

The thus obtained solid electrolyte membrane is sandwiched by the fuel electrode and the oxidant electrode, and is subject to hot press so as to make an electrode-electrolyte-assembly. At this time, a surface of each electrode on which a catalyst is provided is brought into contact with the solid electrolyte membrane. A condition of the hot press is selected depending on the material. When the solid electrolyte membrane or the electrolyte membrane of the surface of the electrode is configured by an organic polymer having a softening temperature and glass transition temperature, the temperature may exceed the softening temperature or the glass transition temperature of these polymers. Specifically, for example, the temperature is no less than 100° C. and no more than 250° C., the pressure is no less than 1 kg/cm² and no less than 100 kg/cm², and the time is no less than 10 seconds and no more than 300 seconds.

Since the fuel cell which is obtained as described above contains an anti-foaming agent in the fuel electrode, an air bubble made of such as carbon dioxicide and carbon monoxide which is generated on a surface of the catalyst layer of the fuel electrode can be quickly removed. Therefore, since an effective surface area of the catalyst electrode is maintained, and the output power of the fuel cell can be increased.

### EXAMPLES

### Example 1

A catalyst electrode for a fuel cell was prepared in the following manner.

3 ml of 5% Nafion solution manufactured by Aldrich was added to 100 mg of Ketjen Black carrying ruthenium-platinum alloy, which was agitated by an ultrasonic mixer at 50° C. for three hours so as to obtain a catalyst paste. A composition of the alloy used in the above was 50 atom % Ru, and a ratio in weight of the alloy and carbon fine powders was 1:1. The catalyst paste was mixed with an anti-foaming agent as listed in Table 1, whereby various kinds of catalyst pastes containing an anti-foaming agent were prepared. The anti-foaming agent was added so that a concentration thereof with respect to a volume of 5% Nafion solution becomes as shown in Table 1.

Carbon paper (TGP-H-120: manufactured by Toray Industries, Inc) with a size of 1 cm×1 cm was immersed in 30 v/v % ethanol solution containing the anti-foaming agent as described in Table 1, whereby carbon paper containing each anti-foaming agent was prepared. The anti-foaming agent was added so that a concentration thereof with respect to a volume of 30 v/v % ethanol solution would become the concentration as shown in Table 1.

2 mg/cm² of the catalyst paste containing same the anti-foaming agent as that in the substrate was applied to the obtained substrate, and then dried at 120° C., whereby various kinds of catalyst electrodes were obtained.

The thus obtained catalyst electrode was put in a container which allows a fuel for a fuel cell to continuously flow onto a surface of the catalyst of the electrode and allows the surface to be observed with an optical microscope. 30 v/v % methanol solution was caused to flow at a flow rate of 5 ml/min on each catalyst electrode, and the state of the surface of the catalyst electrode was observed with an optical microscope. The observation experiment as described above was repeated ten times for each catalyst electrode.

The result showed that with any anti-foaming agent, an air bubble which was generated on the surface of the catalyst electrode had a particle diameter of no less than 10 μm or greater, and that the air bubbles were separated from the surface of the electrode immediately after it was generated, and flowed out with the fuel.

When the air which was generated was collected, and chemically analyzed using gas chromatography, carbon dioxicide and carbon monoxide were detected. Furthermore, when the surface of each catalyst electrode was observed and analyzed using a scanning electron microscope and an Electron Probe Micro Analyzer (EPMA), it was confirmed that the anti-foaming agent was dispersed on the surface of the catalyst electrode and covered a metal catalyst, the carbon particles, and a part of Nafion.

TABLE 1

| | | Concentration |
|---|---|---|
| Type | Anti-foaming agent | (w/w %) |
| Fatty acid-based | Stearic acid | 0.1 |
| Fatty acid | Isoamyl stearate | 0.5 |
| ester-based | Sorbitan monolaurate ester | 0.05 |
| Alcohol-based | Polyoxyalkyleneglycol | 0.01 |
| | 3-heptanol | 0.05 |
| Ether-based | di-t-amyl phenoxyethanol | 0.1 |
| Phosphate | tributyl phosphate | 0.01 |
| based | | |
| Amine-based | Diamyl amine | 0.1 |
| Amide-based | polyalkylene amide | 0.003 |
| Metal | stearate aluminum | 0.1 |
| soap-based | | |
| Sulfate | laurate ester sodium | 0.05 |
| based | | |
| Silicone-based | dimethyl polysiloxane | 0.005 |
| Organic polar | Polypropylene glycol | 0.01 |
| compound-based | | |

### Comparative Example 1

In the same manner as Example 1, a catalyst electrode using a substrate and a catalyst paste which contain no anti-foaming agent was prepared. According to the same method as Example 1, an observation with an optical microscope was conducted 10 times.

As a result, 5 minutes after a fuel was brought into contact with a surface of the catalyst electrode, air bubbles with a particle diameter of approximately 3 mm were generated on the surface of the catalyst electrode. Some of the generated air bubbles were separated from the surface of the electrode as the fuel passed therethrough, three to five air bubbles were adhered to the surface of the catalyst electrode.

When the air which was generated was collected, and chemically analyzed using gas chromatography, carbon dioxicide and carbon monoxide were detected.

From Example 1 and Comparative Example 1, it was confirmed that the catalyst electrode according to this example has an effect of preventing adsorption of air bubbles on the surface thereof and of quickly removing them.

### Example 2

A fuel cell was prepared using the catalyst electrode in Example 1 as a fuel electrode, and the catalyst electrode in Comparative Example 1 as an oxidant electrode. Specifically, the fuel electrode and the oxidant electrode were pressure-bonded on respective sides of Nafion 117 Membrane (manufactured by DuPont: registered trademark) at 120° C., and the obtained catalyst electrode-solid electrolyte membrane assembly was used as a cell for the fuel cell.

30 v/v % methanol solution and oxygen were respectively supplied to the fuel electrode and the oxidant electrode of the obtained cell of the fuel cell at a cell temperature of 60° C. The flow rates of the 30 v/v % methanol solution and the oxygen were 100 ml/min and 100 ml/min, respectively. The voltage-current characteristic when each fuel was supplied was evaluated using a cell performance evaluation apparatus.

The result as shown in Table 2 was obtained on the fuel cells of which the fuel electrodes contain individual anti-foaming agents.

### Comparative Example 2

A cell for a fuel cell was prepared using the catalyst electrodes in Comparative Example 1 for both the fuel electrode and the oxidant electrode and in the same manner as Example 2. As in the same manner as Example 2, 30 v/v % methanol solution was supplied to the fuel electrode of the fuel cell at a cell temperature of 60° C., and the voltage-current characteristic was evaluated.

The maximum output power at this time was 43 mW/cm² (Tables 2 and 3). The results of Example 2 and Comparative Example 2 showed that the output power of the fuel cell was increased by adding an anti-foaming agent to the fuel electrode.

TABLE 2

| | | Maximum output |
|---|---|---|
| Type | Anti-foaming agent | power (mW/cm²) |
| Fatty acid-based | Stearic acid | 50 |
| Fatty acid | Isoamyl stearate | 49 |
| ester-based | Sorbitan monolaurate ester | 48 |
| Alcohol-based | Polyoxyalkyleneglycol | 48 |
| | 3-heptanol | 47 |
| Ether-based | di-t-amyl phenoxyethanol | 49 |
| Phosphate | tributyl phosphate | 47 |
| based | | |
| Amine-based | Diamyl amine | 50 |
| Amide-based | polyalkylene amide | 49 |
| Metal | stearate aluminum | 47 |
| soap-based | | |
| Sulfate | laurate ester sodium | 49 |
| based | | |
| Silicone-based | dimethyl polysiloxane | 48 |
| Organic polar | Polypropylene glycol | 49 |
| compound-based | | |

| | |
|---|---|
| Without an anti-foaming agent (Comparative | 43 |
| Example 2) | |

### Example 3

A catalyst electrode was prepared by further adding polyethylene glycol diester laurate as a mixing accelerator and stabilizer of the anti-foaming agent, when the catalyst paste in Example 1 was prepared and when pretreatment was provided on the carbon paper. The surface of the catalyst electrode was observed using a scanning electron microscope and EMMA.

As a result, it was confirmed that particles of the anti-foaming agent were dispersed more finely on the electrode catalyst prepared in this example compared to the electrode catalyst prepared in Example 1. Using the thus obtained catalyst electrode as a fuel electrode, the voltage-current characteristic was evaluated as in the same manner as Example 2.

The result as shown in Table 3 was obtained on the fuel cells of which the fuel electrodes contain individual anti-foaming agents.

Table 3 showed that the output power of the fuel cell was further increased by using a catalyst electrode to which polyethylene glycol diester laurate was further added as a mixing accelerator and stabilizer, in addition to the anti-foaming agent.

TABLE 3

| | | Maximum output |
|---|---|---|
| Type | Anti-foaming agent | power (mW/cm²) |
| Fatty acid-based | Stearic acid | 53 |
| Fatty acid | Isoamyl stearate | 53 |
| ester-based | Sorbitan monolaurate ester | 54 |
| Alcohol-based | Polyoxyalkyleneglycol | 53 |
| | 3-heptanol | 54 |
| Ether-based | di-t-amyl phenoxyethanol | 52 |
| Phosphate | tributyl phosphate | 53 |
| based | | |
| Amine-based | Diamyl amine | 53 |
| Amide-based | polyalkylene amide | 54 |
| Metal | stearate aluminum | 53 |
| soap-based | | |
| Sulfate | laurate ester sodium | 54 |
| based | | |
| Silicone-based | dimethyl polysiloxane | 53 |
| Organic polar | Polypropylene glycol | 54 |
| compound-based | | |

| | |
|---|---|
| Without an anti-foaming agent (Comparative | 43 |
| Example 2) | |

### Example 4

For the purpose of confirming an effect by adding two or more kinds of the anti-foaming agents selected from Table 3 to the catalyst electrode, catalyst electrodes were prepared respectively using Anti-foaming agent A: consisting of 0.1 w/w % of stearic acid, 0.01 w/w % of tributyl phosphate and 0.005 of w/w % dimethyl polysiloxane, and Anti-foaming agent B: consisting of 0.05 w/w % of sorbitan oleate trimester, 0.1 w/w % of 3-heptyl carbitol, 0.1 w/w % of diamyl amine, 0.05 w/w % of stearate aluminum and 0.05 w/w % of laurate ester sodium, when the catalyst electrode as described in Table 1 was prepared.

A cell for the fuel cell was prepared using each catalyst electrode as a fuel electrode as in the same manner as Example 2, and the voltage-current characteristic was evaluated in the same manner as Example 2.

As a result, the maximum output powers using the Anti-foaming agent A and the Anti-foaming agent B were 50 mW/cm² and 48 mW/cm², respectively. Based on this, it was shown that even when a catalyst electrode containing two or more kinds of anti-foaming agent are used for the fuel electrode, the same effect was maintained as the case where one kind of the anti-foaming agent was contained therein.

From the examples as described above, it was confirmed that the catalyst electrode according to the present invention quickly breaking air bubbles generated on the surface of the catalyst electrode and removing them, by containing an anti-foaming agent. Since this increases an effective surface area of the catalyst electrode, it was also confirmed that output power of the fuel cell was increased by using the catalyst electrode as the fuel electrode of the fuel cell.

In these examples, examples were shown in which methanol solution and ethanol solution were used as a fuel. Other than these, the same effect as the above was obtained when alcohols such as propanol, ethers such as dimethyl ether, cycloparaffins such as cyclohexane, cycloparaffins having a hydrophilic group such as a hydroxyl group, a carboxyl group, an amino group and amide group, and cycloparaffin substitutions were used.

### INDUSTRIAL APPLICABILITY

The present invention realizes a catalyst electrode and a manufacturing method of the same, which is, by adding an anti-foaming agent, capable of suppressing adsorption of an air which is a by-product generated at a fuel electrode on the surface of the electrode when it is used for a fuel cell, and quickly removing the bubble-like air, whereby an effective catalyst area of the fuel cell increases and an output power of the fuel cell is enhanced.

Furthermore, the present invention realizes a fuel cell and a manufacturing method of the same, which is, by adding an anti-foaming agent, capable of suppressing adsorption of an air which is a by-product generated at a fuel electrode on the surface of the electrode and quickly removing the bubble-like air, whereby an effective catalyst area of the fuel cell increases and an output power thereof is enhanced.

1. A catalyst electrode for a fuel cell comprising: a substrate; and a catalyst layer which is formed adjacent to the substrate and which includes a carbon particle supporting a catalyst and a solid polymer electrolyte, and the catalyst electrode for a fuel cell being supplied with a liquid fuel, wherein at least one of the substrate and the catalyst layer contains at least one kind of anti-foaming agent which removes an air which is generated when an organic compound contained in the liquid fuel is decomposed.

2. The catalyst electrode for a fuel cell according to claim 1, wherein the anti-foaming agent may contain at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethyleneglycol oleic ester, a low-mole-addition product of nonyl phenol ethylene oxide, and a low-mole-addition product of Pluronic-type ethylene oxide.

3. The catalyst electrode for a fuel cell according to claim 1, where in both of the substrate and the catalyst layer contain the at least one kind of anti-foaming agent.

4. The catalyst electrode for a fuel cell according to claim 1, wherein at least one of the substrate and the catalyst layer contains at least one of a mixing accelerator and a stabilizer of the at least one kind of anti-foaming agent.

5. (canceled)

6. The catalyst electrode for a fuel cell according to claim 1, wherein the catalyst electrode serves as a fuel electrode for a fuel cell.

7. The catalyst electrode for a fuel cell according to claim 8, wherein the anti-foaming agent contained in the liquid fuel contains at least one selected from the group consisting of a fatty acid-based anti-foaming agent, a fatty acid-ether-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

8. The catalyst electrode for a fuel cell according to claim 7, wherein the at least one kind of anti-foaming agent contained in the liquid fuel is the same as the at least one kind of anti-foaming agent contained in at least one of the substrate and the catalyst layer.

9. The catalyst electrode for a fuel cell according to claim 7, wherein the at least one kind of anti-foaming agent contained in the liquid fuel is different from the at least one kind of anti-foaming agent contained in at least one of the substrate and the catalyst layer.

10. A fuel cell comprising:
a solid electrolyte membrane;
a fuel electrode adjacent to a first surface of the solid electrolyte membrane and which is supplied with a liquid fluid; and
an oxidant electrode adjacent to a second surface of the solid electrolyte membrane, wherein
the fuel electrode includes a substrate and a catalyst layer which is formed adjacent to the substrate and which includes a carbon particle carrying a catalyst and a solid polymer electrolyte, and
at least one of the substrate and the catalyst layer of the fuel electrode contains at least one kind of anti-foaming agent which removes an air which is generated when an organic compound contained in the liquid fuel is decomposed.

11. The fuel cell according to claim 10, wherein the anti-foaming agent contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

12. The fuel cell according to claim 10, wherein both of the substrate and the catalyst layer of the fuel electrode contains the at least one kind of anti-foaming agent.

13. The fuel cell according to claim 10, wherein at least one of the substrate and the catalyst layer of the fuel electrode contains at least one of a mixing accelerator and a stabilizer of the at least one kind of anti-foaming agent.

14. The fuel cell according to claim 10, wherein a liquid fuel supplied to the fuel electrode contains an organic compound and at least one kind of anti-foaming agent.

15. The fuel cell according to claim 14, wherein the anti-foaming agent contained in the liquid fuel contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

16. The catalyst electrode for a fuel cell according to claim 15, wherein the at least one kind of anti-foaming agent contained in the liquid fuel is the same as the at least one kind of anti-foaming agent contained in at least one of the substrate and the catalyst layer.

17. The catalyst electrode for a fuel cell according to claim 15, wherein at least one kind of anti-foaming agent contained in the liquid fuel is different from the at least one kind of anti-foaming agent contained in at least one of the substrate and the catalyst layer.

18. A manufacturing method of a catalyst electrode for a fuel cell which is supplied with a liquid fluid, the method comprising the step of forming a catalyst layer on a surface of a substrate coated with a solution containing a conductive particle carrying a catalyst, a particle of a solid polymer electrolyte, and at least one kind of anti-foaming agent which removes an air which is generated when an organic compound contained in the liquid fuel is decomposed on at least a part of the surface of the substrate.

19. The manufacturing method of a catalyst electrode for a fuel cell according to claim 18, wherein the anti-foaming agent contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

20. The manufacturing method of a catalyst electrode for a fuel cell according to claim 18, wherein the solution to be applied contains at least one of a mixing accelerator and a stabilizer of the at least one kind of anti-foaming agent.

21. The manufacturing method of a catalyst electrode for a fuel cell according to claim 18, further comprising the step of bringing the substrate into contact with an anti-foaming-agent-containing substance which is in either one of a liquid state and an air state and which contains at least one kind of anti-foaming agent so as to provide the substrate with the at least one kind of anti-foaming agent, wherein a solution containing an anti-foaming agent is applied on the substrate provided with the anti-foaming agent.

22. The manufacturing method of a catalyst electrode for a fuel cell according to claim 18, further comprising the step of dispersing at least one kind of anti-foaming agent in a raw material of the substrate, so as to form the substrate in which the at least one kind of anti-foaming agent is dispersed, wherein a solution containing an anti-foaming agent is applied on the substrate provided with the anti-foaming agent.

23. A manufacturing method of a catalyst electrode for a fuel cell which is supplied with a liquid fluid, the method comprising the steps of: bring a substrate into contact with an anti-foaming-agent-containing substance which contains at least one kind of anti-foaming agent which removes an air which is generated when an organic compound contained in the liquid fuel is decomposed and which is in either one of a liquid state and an air state so as to provide the substrate with the at least one kind of anti-foaming agent; and
forming a catalyst layer on at least a part of a surface of the substrate.

24. The manufacturing method of a catalyst electrode for a fuel cell according to claim 23, wherein the step of forming a catalyst layer includes coating a solution which contains a conductive particle carrying a catalyst substance and a particle containing a solid polymer electrolyte on the substrate.

25. The manufacturing method of a catalyst electrode for a fuel cell according to claim 23, wherein the anti-foaming agent contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

26. The manufacturing method of a catalyst electrode for a fuel cell according to claim 23, wherein the anti-foaming-agent-containing substance contains at least one of a mixing accelerator and a stabilizer of the at least one kind of anti-foaming agent.

27. The manufacturing method of a catalyst electrode for a fuel cell according to claim 23, wherein the step of bringing into contact with an anti-foaming-agent-containing substance includes a step of applying the anti-foaming-agent-containing substance in a liquid state on the substrate.

28. The manufacturing method of a catalyst electrode for a fuel cell according to claim 23, wherein the step of bringing into contact with an anti-foaming-agent-containing substance includes a step of immersing the substrate in the anti-foaming-agent-containing substance in a liquid state.

29. The manufacturing method of a catalyst electrode for a fuel cell according to claim 23, wherein the step of bringing into contact with an anti-foaming-agent-containing substance includes a step of spraying the anti-foaming-agent-containing substance in an air state on the substrate.

30. The manufacturing method of a catalyst electrode for a fuel cell according to claim 23, wherein the step of forming a catalyst layer includes a step of forming the catalyst layer coated with a solution containing a conductive particle carrying a catalyst, a particle of a solid polymer electrolyte, and at least one kind of anti-foaming agent on at least a part of the surface of the substrate.

31. A manufacturing method of a catalyst electrode which is supplied with a liquid fluid for a fuel cell, the method comprising the steps of: dispersing at least one kind of anti-foaming agent which removes an air which is generated when an organic compound contained in the liquid fuel is decomposed in a raw material of a substrate so as to form the substrate in which the at least one kind of anti-foaming agent is dispersed; and forming a catalyst layer on at least a part of a surface of the substrate.

32. The manufacturing method of a catalyst electrode for a fuel cell according to claim 31, wherein the step of forming a catalyst layer includes coating a solution which contains a conductive particle carrying a catalyst substance and a particle containing a solid polymer electrolyte on the substrate.

33. The manufacturing method of a catalyst electrode for a fuel cell according to claim 31, wherein the anti-foaming agent contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

34. The manufacturing method of a catalyst electrode for a fuel cell according to claim 31, wherein at least one of a mixing accelerator and a stabilizer of the at least one kind of anti-foaming agent is further dispersed in the material of the substrate.

35. The manufacturing method of a catalyst electrode for a fuel cell according to claim 31, wherein the step of forming a catalyst layer includes a step of forming the catalyst layer coated with a solution containing a conductive particle carrying a catalyst, a particle of a solid polymer electrolyte, and at least one kind of anti-foaming agent on at least a part of the surface of the substrate.

36. A manufacturing method of a catalyst electrode for a fuel cell which is supplied with a liquid fluid, the method comprising the steps of: forming a catalyst layer on a surface of a substrate coated with a solution containing a conductive particle carrying a catalyst and a particle of a solid polymer electrolyte on at least a part of the surface of the substrate, and
bringing the catalyst layer into contact with an anti-foaming-agent-containing substance which contains at least one kind of anti-foaming agent which removes an air which is generated when an organic compound contained in the liquid fuel is decomposed and which is in either one of a liquid state and an air state so as to provide the catalyst layer with the at least one kind of anti-foaming agent.

37. The manufacturing method of a catalyst electrode for a fuel cell according to claim 36, wherein the anti-foaming agent contains at least one selected from the group consisting of a fatty acid-based anti-foaming agent, a fatty acid ester-based anti-foaming agent, an alcohol-based anti-foaming agent, an ether-based anti-foaming agent, a phosphate based anti-foaming agent, an amine-based anti-foaming agent, an amide-based anti-foaming agent, a metal soap-based anti-foaming agent, a sulfate based anti-foaming agent, a silicone-based anti-foaming agent, a mineral oil-based anti-foaming agent, polypropylene glycol, low-molecular-weight polyethylene glycol oleic ester, a low-mole-addition product of nonyl phenol ethylene oxide, and a low-mole-addition product of Pluronic-type ethylene oxide.

38. The manufacturing method of a catalyst electrode for a fuel cell according to claim 36, wherein the anti-foaming-agent-containing substance contains at least one of a mixing accelerator and a stabilizer of the at least one kind of anti-foaming agent.

39. The manufacturing method of a catalyst electrode for a fuel cell according to claim 36, wherein the step of bringing into contact with the anti-foaming-agent-containing substance includes a step of applying the anti-foaming-agent-containing substance in a liquid state on the substrate.

40. The manufacturing method of a catalyst electrode for a fuel cell according to claim 36, wherein the step of bringing into contact with the anti-foaming-agent-containing substance includes a step of immersing the substrate in the anti-foaming-agent-containing substance in a liquid state.

41. The manufacturing method of a catalyst electrode for a fuel cell according to claim 36, wherein the step of bringing into contact with an anti-foaming-agent-containing substance includes a step of spraying the anti-foaming-agent-containing substance in an air state on the substrate.

42. A manufacturing method of a fuel cell which is supplied with a liquid fluid, the method comprising the steps of: forming a catalyst layer so as to obtain a catalyst electrode coated with a solution containing a conductive particle carrying a catalyst, a particle of a solid polymer electrolyte, and at least one kind of anti-foaming agent which removes an air which is generated when an organic compound contained in the liquid fuel is decomposed on at least a part of a surface of a substrate; and
abutting and pressure-bonding the catalyst electrode with a solid electrolyte membrane.

43. A manufacturing method of a fuel cell which is supplied with a liquid fluid, the method comprising the steps of: bringing a substrate into contact with an anti-foaming-agent-containing substance which contains at least one kind of anti-foaming agent which removes an air which is generated when an organic compound contained in the liquid fuel is decomposed and which is in either one of a liquid state and an air state so as to provide the substrate with the at least one kind of anti-foaming agent;
forming a catalyst layer on at least a part of a surface of a substrate so as to obtain a catalyst electrode; and
abutting and pressure-bonding the catalyst electrode with a solid electrolyte membrane.

44. A manufacturing method of a fuel cell which is supplied with a liquid fluid, the method comprising the steps of: dispersing at least one kind of anti-foaming agent which removes an air which is generated when an organic compound contained in the liquid fuel is decomposed in a raw material of a substrate so as to form the substrate in which the at least one kind of anti-foaming agent is dispersed;
forming a catalyst layer on at least a part of a surface of the substrate, so as to obtain a catalyst electrode; and
abutting and pressure-bonding the catalyst electrode with a solid electrolyte membrane.

45. A manufacturing method of a fuel cell which is supplied with a liquid fluid, the method comprising the steps of: forming a catalyst layer coated with a solution containing a conductive particle carrying a catalyst and a particle of a solid polymer electrolyte on at least a part of a surface of a substrate; obtaining a catalyst electrode by bringing the catalyst layer into contact with an anti-foaming-agent-containing substance which contains at least one kind of anti-foaming agent which removes an air which is generated when an organic compound contained in the liquid fuel is decomposed and which is in either one of a liquid state and an air state so as to provide the catalyst layer with the at least one kind of anti-foaming agent; and
abutting and pressure-bonding the catalyst electrode with a solid electrolyte membrane.
